(19) United States
(12) Patent Application Publication
(10) Pub. No.: US 2025/0008859 A1
(43) Pub. Date: Jan. 9, 2025

(54) Agricultural Soil Processing Device and Method of Folding the Agricultural Device

(71) Applicant: Bednar Fmt s.r.o., Praha 9, Vinor (CZ)

(72) Inventors: Jiri Peterac, Zamosti-Blata (CZ); Pavel Forman, Praha 9, Vinor (CZ); Pavel Syrovatka, Klenec (CZ); Vojtech Bednar, Praha 9, Vinor (CZ)

(73) Assignee: Bednar Fmt s.r.o., Praha 9, Vinor (CZ)

(21) Appl. No.: 18/713,375

(22) PCT Filed: Nov. 24, 2022
(86) PCT No.: PCT/CZ2022/050122

§ 371 Date: May 24, 2024

(30) Foreign Application Priority Data
Nov. 24, 2021 (CZ) PV 2021-531

(51) Int. Cl. A01B 73/06; A01B 59/041; A01B 73/04; A01C 7/16

(52) U.S. Cl. CPC A01B 73/067; A01B 59/041; A01B 73/048; A01C 7/16

(57) ABSTRACT

An agricultural soil processing device comprises a central frame provided with a coupling mechanism adapted for mounting to a towing device provided with a mount. Wings are rotationally mounted to the central frame. Sections of working units are rotationally mounted to the wings. The sections are comprised of at least one row of working units, at least one travel wheel mounted to the wing by a locking rotational mechanism, and support rods rotationally mounted to the wings and connected to the mount. The support rod comprises a tilting part and a tipping part, wherein the tilting part and the tipping part are rotationally connected by an articulated joint.

### TECHNICAL FIELD

The invention relates to an agricultural soil processing device, addressing the structure of support rods ensuring the stability of the device during soil processing and the subsequent folding or unfolding of the device for transport.

### BACKGROUND OF THE INVENTION

In the current state of the art, agricultural soil processing machines that are provided with struts due to their heavy weight and large width are known. These struts are mounted on the side of the agricultural device, usually on a rotationally mounted wing equipped with sections with working units. The struts connect the agricultural device to a towing device, e.g. a tractor, trailer, or mobile seed hopper, and thus ensure the stability of the agricultural device, uniform traction, and contact over the entire width of the agricultural device, and to some extent compensate for the mechanical stress caused by uneven loading of the individual sides, e.g. due to uneven ground. An agricultural device with such struts is described e.g. in the document U.S. Pat. No. 2,418,937.

If the agricultural device is too wide, it is necessary for road transport to fold it into a transport position, where the sections of working units are reclined and the wings are folded along the central axis of the agricultural device. At this point, the effective folding of the side struts needs to be resolved. Due to their length, they can protrude into the road or the towing device.

### SUMMARY OF THE INVENTION

The above shortcomings are to some extent eliminated by an agricultural soil processing device comprising a central frame provided with a coupling mechanism adapted for mounting to a towing device provided with a mount, wings rotationally mounted to the central frame, sections of working units rotationally mounted to the wings, where the sections are composed of at least one row of working units, at least one travel wheel mounted to the wing by a locking rotational mechanism, and support rods rotationally mounted to the wings and connected to the mount. The shortcomings of the prior art are eliminated by the fact that the support rod consists of a tilting part and a tipping part, wherein the tilting part and the tipping part are rotationally connected by an articulated joint. This embodiment ensures the mechanical stability of the agricultural device in the working position. In the transport position, the support rods are then tipped to the agricultural device, wherein their tilting part is tilted upwards. The agricultural device is thus wide enough in the transport position to ensure that its transport meets safety standards.

The agricultural device further preferably comprises at least one distribution head rotationally mounted on a section of working units. Distribution heads are an important component of this type of sowing agricultural devices. Their rotational mounting to the section allows reclining for transport.

Preferably, the mount and the tilting part of the support rod are provided with latches that ensure their connection in the working position. This type of connection provides sufficient strength and security of the connection even under demanding working conditions, preferably this connection is then further secured by a lock.

Preferably the support rods are provided with a strut that is rotationally mounted to the support rod and the wing. The support rod strut ensures that the support rod is tipped to the working sections.

Preferably, the articulated joint connecting the tilting and tipping part of the support rod is provided with an articulated joint strut which is mounted to both parts and, by its extension or retraction, ensures the lifting of the tilting part for transport. Preferably, this strut is embodied as a piston of a hydraulic cylinder.

Preferably, the wings are provided with transport latches that can be connected to each other to increase the strength of the connection of the left and right wings in the transport position of the agricultural device.

The shortcomings mentioned above are to some extent further eliminated by a method of folding the agricultural soil processing device, which comprises at least a central frame, wings rotationally mounted to the central frame and provided with transport latches, sections of working units rotationally mounted to the wings and provided with at least one row of working units, at least one travel wheel mounted to each wing by a locking rotational mechanism, and support rods rotationally mounted to the wings and connected to a towing device mount, wherein the support rod comprises a tilting part and a tipping part connected rotationally by an articulated joint. The folding of the agricultural device is performed by the following sequence of steps:
a) disconnecting the support rod and the towing device mount;
b) lifting the sections of working units by rotating the sections around the wings;
wherein steps a) and b) are performed in any order
c) folding the first wing to the central axis of the agricultural device by rotating the wing at the point of rotational connection to the central frame;
d) folding the second wing to the central axis of the agricultural device by rotating the wing at the point of rotational connection to the central frame;
e) tilting the tilting part of the support rod to the vertical position;
f) tipping the tipping part of the support rod to the wing;
g) rotating the travel wheels in the direction of travel of the agricultural device, and
h) connecting the transport latches of the opposite wings.

In a preferred embodiment, the agricultural device further comprises at least one distribution head rotationally mounted on a section of working units. The distribution head is reclined to the section of working units after the step of disconnecting the support rod and the mount and before the step of folding the wing to the central axis of the agricultural device.

Preferably, the articulated joint is provided with an articulated joint strut mounted to the tilting part and the tipping part, wherein the tilting of the tilting part of the support rod is performed by retracting the articulated joint strut.

Preferably, the support rods are provided with a support rod strut rotationally mounted to the support rod and the wing, wherein reclining of the reclining part is performed by retracting the support rod strut.

### DESCRIPTION OF THE DRAWINGS

The summary of the invention is further clarified using exemplary embodiments thereof, which are described with reference to the accompanying drawings, in which:

FIG. 1 shows an agricultural soil processing device, viewed from above. For the sake of simplicity and illustration, details are shown for the right wing only.

FIG. 2 shows the agricultural soil processing device, viewed from the side.

FIG. 3 shows the agricultural soil processing device, viewed from the rear. For the sake of simplicity and illustration, details are shown for the left wing only.

FIG. 4 shows a detail of a latch connection of a support rod and a mount.

FIG. 5 shows a detail of a latch connection of the wings in the transport position.

FIG. 6a shows the agricultural soil processing device moving from the working position to the transport position. The right wing is already in the transport position, with the distribution heads and sections of working units reclined and the wing tipped to the central axis. At the left wing, the distribution heads and the working sections are reclined, but it remains connected by the support rod to the mount.

FIG. 6b shows the agricultural soil processing device moving from the working position to the transport position. The right wing is already in the transport position. At the left wing, the distribution heads and the working sections are reclined. The latch connection of the support rod and the mount is already disconnected and the section is reclining to the central axis of the agricultural device.

FIG. 6c shows the agricultural soil processing device moving from the working position to the transport position, where the left section is already tipped to the central axis of the agricultural device, but the travel wheels of this section are still in the working position.

FIG. 7 shows the agricultural soil processing device in the transport position.

FIG. 8 shows a detail of the connection of a wing and a central frame by a connecting element and a balancing piston.

### EXEMPLARY EMBODIMENTS OF THE INVENTION

The invention will be further clarified using exemplary embodiments with reference to the respective drawings, which, however, have no limiting effect from the point of view of the scope of protection.

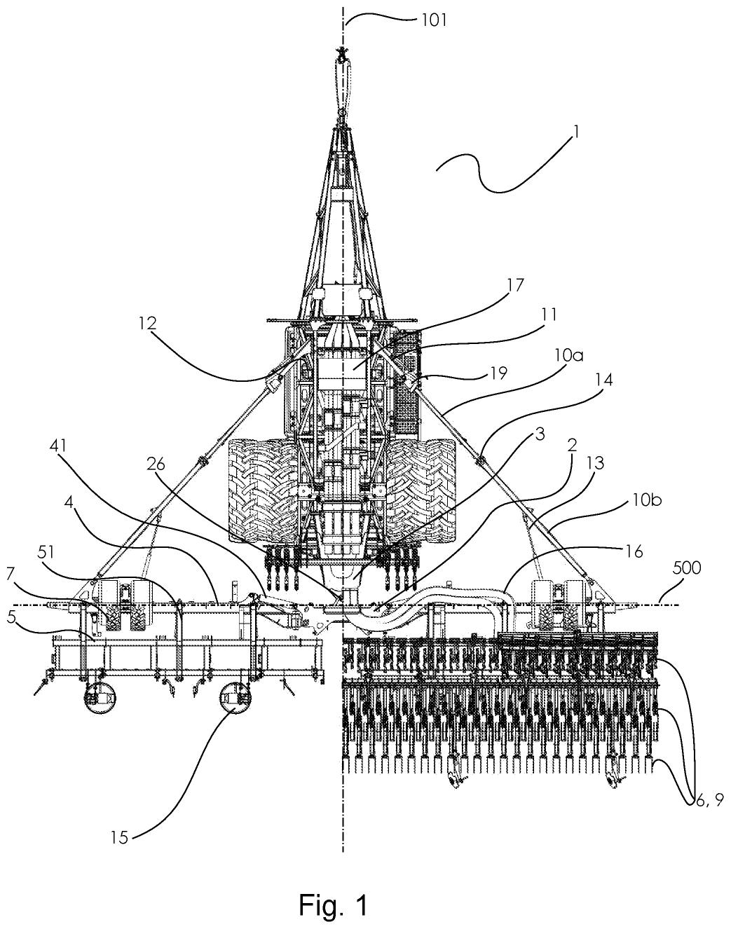

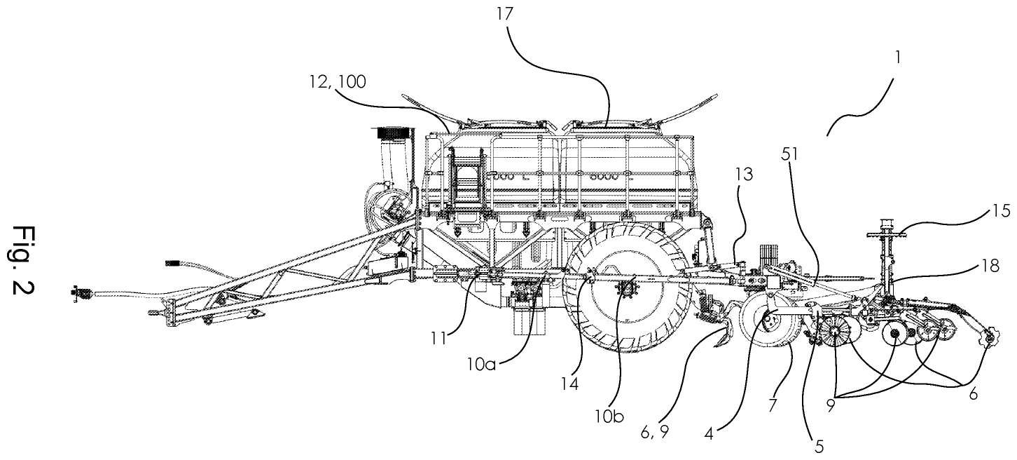

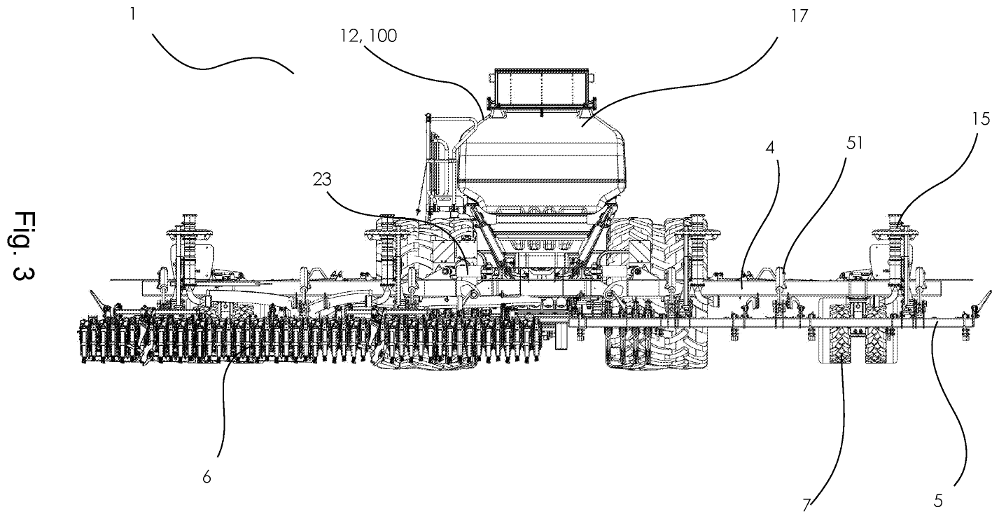

The agricultural soil processing device 1 shown in FIGS. 1, 2, and 3 comprises a central frame 2 provided with a coupling mechanism by means of which it can be connected to a towing device 100. The choice of the towing device 100 depends on the specific application for which the agricultural soil processing device 1 is used. For example, the towing device 100 may be, e.g., a tractor, a combine harvester, or a sowing machine 12 which is coupled behind the tractor. The towing device 100 is provided with at least two mounts 11.

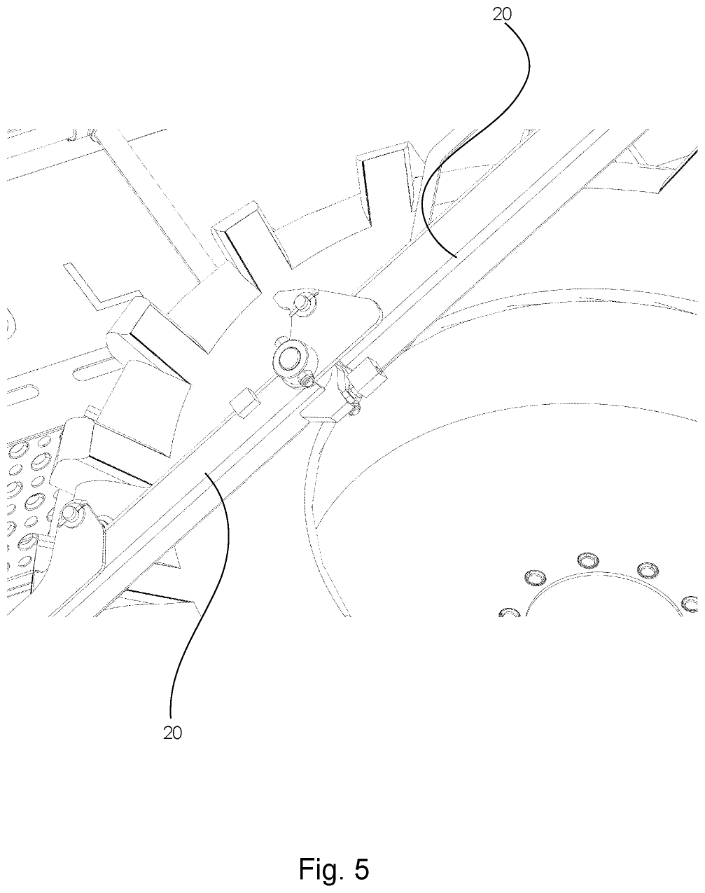

The wings 4 are rotationally mounted to the central frame 2. The rotational mounting of the wings 4 is locked. The axis 400 of rotation of the rotational mounting of the wings 4 is vertical, perpendicular to the direction of travel of the agricultural soil processing device 1. The rotational movement of the wings 4 is provided by a wing strut 41, which is embodied, for example, as a hydraulic piston. There are, for example, two wings 4—a left wing 4 and a right wing 4. The orientation of the wings 4 is taken with respect to the direction of travel of the agricultural soil processing device 1. The wings 4 are designed symmetrically, where the axis of symmetry is given by the central axis 101 of the agricultural device 1. Section 5 of working units 6 is rotationally mounted to the wing 4. The axis 500 of rotation of the rotational mounting of the sections 5 is horizontal and perpendicular to the central axis 101 of the agricultural device. The rotary movement of the sections 5 is provided by a strut 51 of the sections, which connects the section 5 to the wing 4. The strut 51 of the sections is rotatably attached to the wing 4 such that the strut 51 can be rotated at the point of connection of the piston 51 of the sections and the wing 4, but the point of mounting on the wing 4 remains fixed. For example, each section 5 of working units is provided with three struts 51. The section 5 of working units 6 is provided with at least two rows of working units 6. The working units 6 may be, for example, blades, sets of pairs of mutually offset rotational discs in various shape embodiments called coulters, harrows, levelers, sowing coulters, and others. The scope of protection of the invention is not limited to a type or order of working units. A person skilled in the art will select the specific types and order of working units depending on the application for which the agricultural device 1 is currently used. Travel wheels Z are rotationally mounted to the wings 4 at their end part. The travel wheels Z ensure the travel of the agricultural device connected by the coupling mechanism 3 to the towing device 100. The travel wheels Z are mounted to the wings 4 by means of a locking rotational mechanism 8, which provides rotary movement of the travel wheels 7 relative to the agricultural device 1, whereby the angle between the axis passing through the centre of the travel wheels Z and the central axis 101 of the agricultural device changes during this rotary movement. There are for example at least two travel wheels Z, wherein exactly one travel wheel 4 is mounted on each wing 4. The travel wheels Z may be for example mounted using a spring element, e.g. a spring, which serves to suppress vibrations and shocks of the agricultural device 1 when travelling over the soil to be processed. In addition, near the travel wheels Z at the end of the wings 4 are located transport latches 20 adapted to mutually engage and connect the left and right transport latches 20 to each other, which is shown in detail in FIG. 5.

The agricultural soil processing device 1 further comprises at least two support rods 10 rotationally mounted to the wing 4 in the wing end region and to the mounts 11 located on the towing device 100. The connection of the support rod 10 to the mount 11 is embodied by a simple mechanical joint that can be quickly disconnected to ensure the disconnection of the support rod 10 and the mount 11. The axis of the rotational support rod 10 to the wing 4 is vertical and parallel to the axis 400 of rotation of the rotational mounting of the wings 4. The support rod 10 is for example further connected to the wing 4 by at least one strut 13 of the support rod, which is rotationally attached to the support rod 10 and the wing 4 by its ends. An exemplary embodiment of the invention utilises two struts 13 of the support rod, where one strut 13 of the support rod is attached to the tipping part 10b of the support rod from the side, the other from the top. The support rod 10 consists of a tilting part 10a of the support rod and a tipping part 10b of the support rod of two parts 10a and 10b, which are connected by an articulated joint 14. The change in position of the reclining tilting part 10a relative to the tipping part 10b is performed by rotation in the axis of the articulated joint 14 by extending or retracting the articulated joint strut 14a.

The agricultural soil processing device 1 is further provided with distribution heads 15 adapted for the distribution of granular material, such as seed or various types of fertiliser. At least one distribution head 15 is rotationally mounted to each section 5 of working units by a reclinable mount 18. The reclinable mount 18 ensures that the distribution head 15 can be moved from the transport position of the head to the working position of the head and vice versa. For example, two distribution heads 15 are mounted to each section 5 of working units. Inlets 16 of granular material, which are mounted to the wings 5 of the agricultural device, lead to the distribution heads 15. The other end of the inlets 16 is mounted to the hopper 17, in which the distributed granular material is located. The hopper 17 is located for example on the towing device 100.

In an exemplary embodiment, the agricultural soil processing device 1 is operable in two positions which differ from each other in the spatial arrangement of the individual components of which the agricultural device 1 is composed.

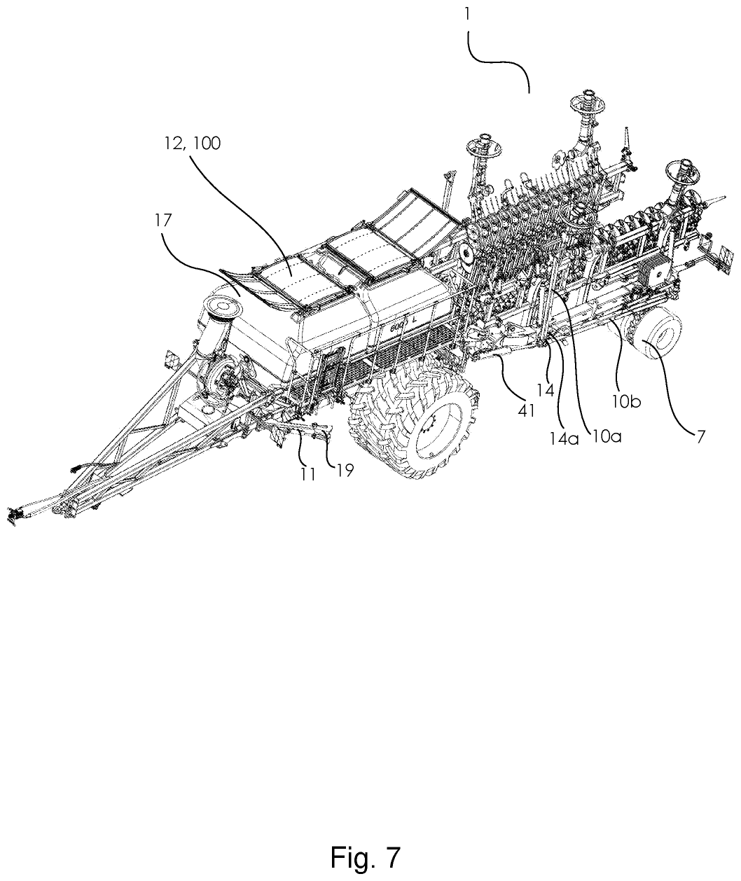

The working position shown in FIGS. 1, 2, and 3 is used in the active use of the agricultural device 1 during soil processing. The transport position shown in FIG. 7 is used for the transport of the agricultural device 1, e.g. during road transport.

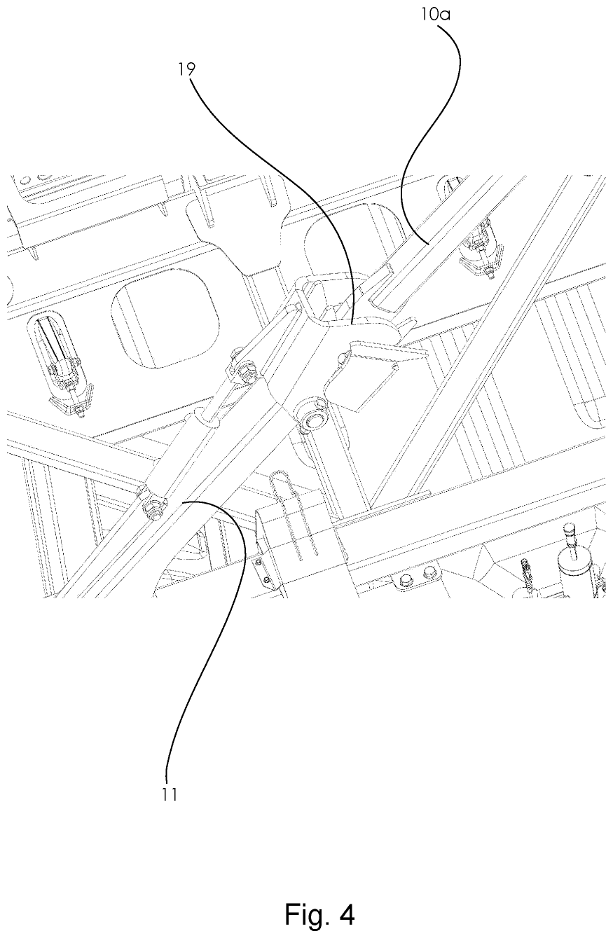

In the working position of the agricultural soil processing device 1, the wings 4 are extended and the wing struts 41 are in a compacted state. The sections 5 of working units are reclined such that the working units 6 are in contact with the ground. The reclining of the sections 5 is performed in such a way that the struts 51 of the sections are in the extended state. In an exemplary embodiment of the invention, where the agricultural device 1 is provided with the distribution heads 15, the latter are erected upwards to the operating position. Erection of the distribution heads 15 to the working position is performed by tilting the reclinable mount 18, by which the distribution heads 15 are mounted to the working sections 5. Further, in the working position of the agricultural device 1, the support rods 10 are tilted away from the wings 4 by the extension of the struts 13 of the support rod and connected to the mount 11 on the sowing machine 12 or the towing device 100. The tilting part 10a of the support rod is reclined and horizontally oriented. The tilting of the tilting part 10a is performed by extending the articulated joint strut 14a. The connection of the support rod 10 and the mount 11 is embodied by means of a simple and quickly disconnectable mechanism, which is operated either automatically or manually by the operator of the agricultural device 1. This connection is made for example by means of a pair of latches 19, where the first latch 19 is located on the mount 11 and the second latch 19 is located on the tilting part 10a of the support rod. The connection of the latches 19 is secured by a lock as shown in FIG. 4. Further, in the working position of the agricultural soil processing device 1, the struts 13 of the support rod connecting the support rods 10 and the wings 4 are in the extended state. Furthermore, in the working position of the agricultural device 1 the travel wheels 7 are oriented according to the direction of travel of the agricultural device 1.

In the transport position of the agricultural soil processing device 1, the wings 4 are reclined along the central axis 101 of the agricultural device and the wing struts 41 are in the extended state. The sections 5 of working units are tilted such that the working units 6 are above the level of the travel wheels 7. The tilting of the sections 5 is performed in such a way that the struts 51 of the sections are in the retracted state. In an exemplary embodiment of the invention, where the agricultural device 1 is provided with distribution heads 15, the latter are reclined into the transport position along the sections 5, however they still face upwards due to the erection of the sections 5. The reclining of the distribution heads 15 to the transport position is performed by reclining the reclinable mount 18 by which the distribution heads 15 are mounted to the working sections 5. Further, in the transport position of the agricultural device 1, the support rods 10 are reclined and disconnected from the mount 11 on the sowing machine 12 or the towing device 100. Thus, the disconnectable mechanism connecting the support rods 10 and the mounts 11 is disconnected. Further, in the transport position of the agricultural soil processing device 1, the struts 13 of the support rod connecting the support rods 10 and the wings 4 are in the retracted state. The support rods 10 are thus reclined along the wings 4 of the device. At the same time, the support rods 10 are bent at the articulated joint 14 by the retraction of the articulated joint strut 14a and the tilting part 10a thus faces upwards while the tipping part 10b is reclined along the wing 4 of the device. Further, in the transport position of the agricultural device 1, the travel wheels Z are oriented according to the direction of travel of the agricultural device 1. Compared to the working position, the travel wheels Z are rotated relative to the agricultural device 1 by 90° by rotating the locking rotational mechanism 8. The transport latches 20 are engaged and connected in the transport position of the agricultural device 1, thereby connecting the wings 4 together.

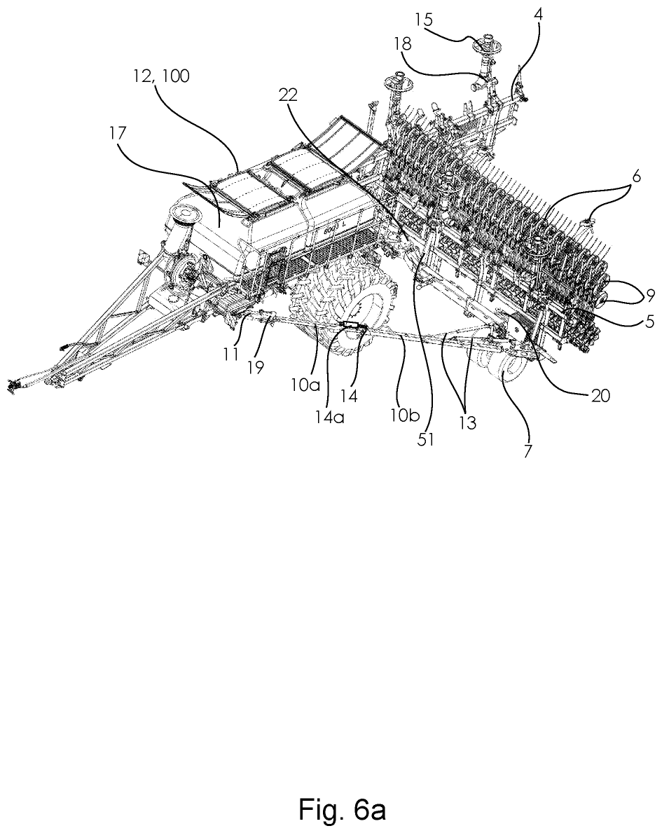

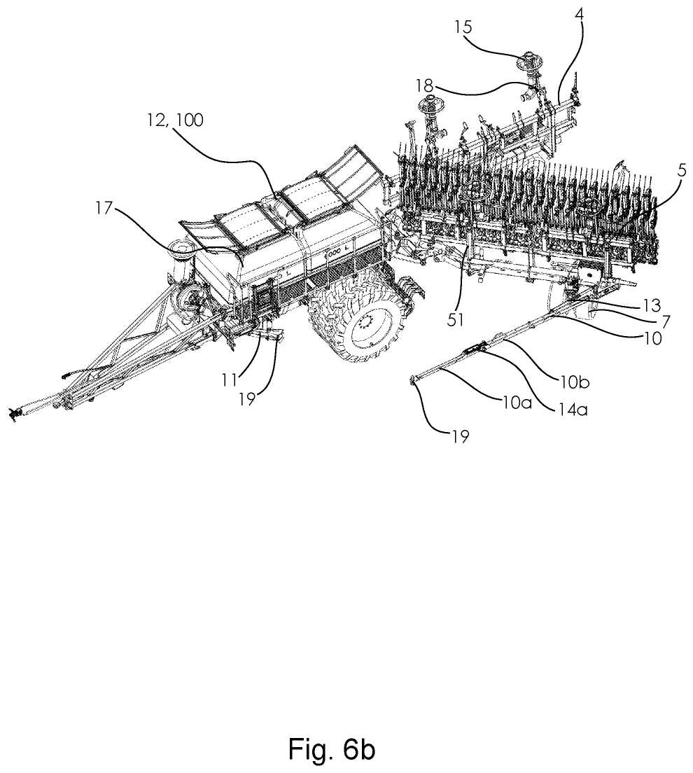

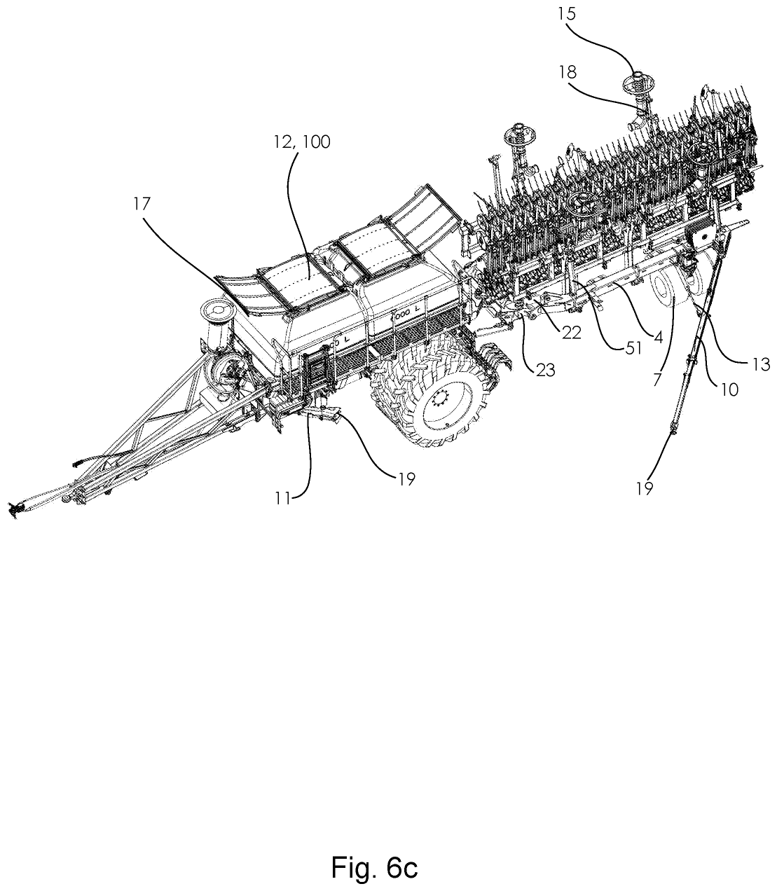

The agricultural soil processing device 1 is moved from the transport position to the working position by the method shown in FIG. 6a-6c. Moving to the working position is performed by the following sequence of steps.
The first step is to release the locking rotational mechanism 8, which allows the orientation of the travel wheel Z relative to the agricultural device to be changed.
The second step is to disconnect the transport latches 20, thereby disconnecting the wings 4 from each other.
The third step is to rotate the travel wheels 7, thereby changing their orientation relative to the agricultural device 1 by 90°, wherein the travel wheels 7 are still in contact with the travel surface. After rotating the travel wheels 7 the wheels 7 are locked in the working position by means of the locking rotational mechanism 8. The order of performing the first three steps can be changed as needed.
The fourth step is to tilt the tipping part 10b of the support rod away from the wing 4 by extending the strut 13 of the support rod.
The fifth step is to recline the tilting part 10a of the support rod from the vertical position to the horizontal position by rotating it about the axis of the articulated joint 14, which is performed by extending the strut 14a of the support rod.
The sixth step is to unfold the wings 4, wherein the wings 4 are unfolded one at a time, where either the left wing 4 is unfolded first followed by the right wing 4 or vice versa, where the right wing 4 is unfolded first followed by the left wing 4. The unfolding of the wings 4 is performed by retracting the wing struts 41, thereby rotating the wing 4 by 90° about the axis of rotational connection of the wing 4 and the central frame 2.
The seventh step is to recline the sections 5 of working units by extending the struts 51 of the sections, thereby rotating the sections 5 by 90° about the axis of rotational connection of the section 5 and the wing 4.
The eighth step is to lift the distribution heads 15 to the working position by erecting the reclinable mount 18, thereby changing the orientation of the distribution heads relative to the sections 5 by 90°.
The ninth step is to connect the support rod 10 to the mount 11, which is performed by connecting the latches 19 of the support rod.

The order of performing the seventh, eighth, and ninth step can be changed as needed. The downforce of the working units 6 on the soil being processed can then be regulated.

The agricultural soil processing device 1 is moved from the working position to the transport position by an inverse sequence of steps compared to moving the agricultural device from the transport position to the working position. Moving the agricultural device 1 from the working position to the transport position is performed by the following sequence of steps.
The first step is to disconnect the support rod 10 and the mount 11 by disconnecting the latches 19 of the support rod. This step can be performed manually by the operator of the agricultural device 1 or by an automatic mechanism, e.g. based on a hydraulic piston or electronic securing. The exact method of disconnecting the support rod 10 and the mount is not within the scope of the present invention and is a trivial matter to one skilled in the relevant art.
The second step is to recline the distribution heads 15 into the transport position by reclining the reclinable mount 18, thereby changing the orientation of the distribution heads relative to the sections 5 by 90° and thus bringing the distribution head 15 adjacent to the section 5.
The third step is to lift the sections 5 of working units by retracting the struts 51 of the sections, thereby rotating the sections 5 by 90° about the axis of rotational connection of the section 5 and the wing 4. The order of performing the first three steps can be changed as needed.
The fourth step is to fold the wings 4, wherein the wings 4 are folded one at a time, where either the left wing 4 is folded first followed by the right wing 4 or vice versa, where the right wing 4 is folded first followed by the left wing 4. The folding of the wings 4 is performed by extending the wing struts 41, thereby rotating the wing 4 by 90° about the axis of rotational connection of the wing 4 and the central frame 2.
The fifth step is to tilt the tilting part 10a of the support rod from the horizontal position to the vertical position by rotating it about the axis of the articulated joint 14, which is performed by retracting the strut 14a of the support rod.
The sixth step is to tip the tipping part 10b of the support rod to the wing 4 by retracting the strut 13 of the support rod.
The seventh step is to release the locking rotational mechanism 8 and rotate the travel wheels 7, thereby changing their orientation relative to the agricultural device 1 by 90°, wherein the travel wheels 7 are still in contact with the travel surface.
The eighth step is to connect the transport latches 20, thereby connecting the wings 4 together.
The ninth step is to secure the locking rotational mechanism 8.

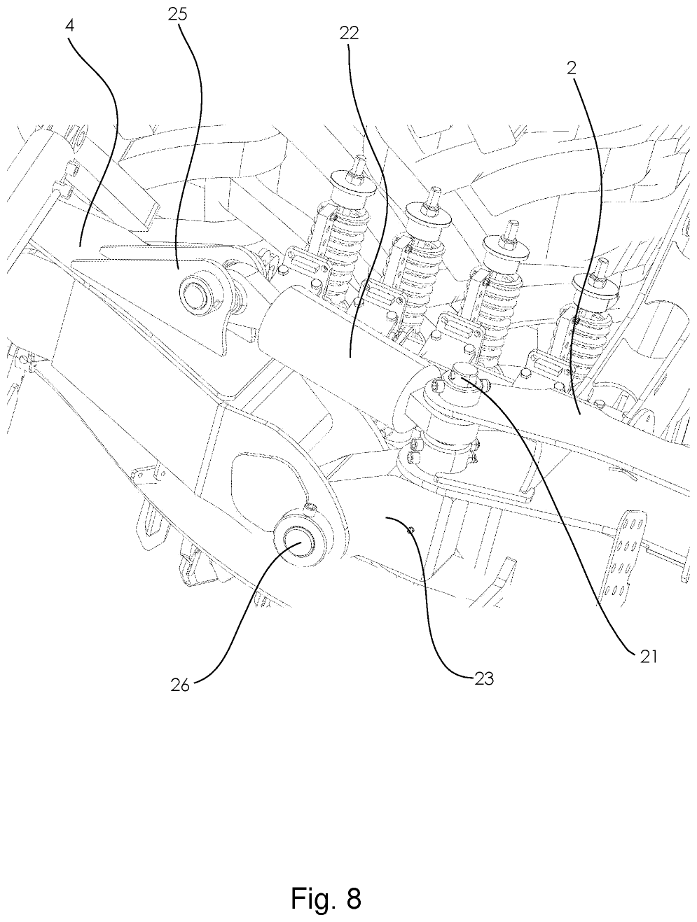

In an exemplary embodiment of the invention, the rotational connection of the wing 4 and the central frame 2 is performed by means of the connecting mechanism described below and shown in FIG. 8. The central frame 2 is provided with a vertically positioned frame pin 21. Further, the first end of the balancing piston 22 is rotationally mounted at the point of location of the frame pin 21, i.e. the axis of rotation of the rotational seating of the balancing piston 22 corresponds to the vertical axis of the frame pin 21. The frame pin 21 passes through the connecting element 23, which is rotationally seated around the frame pin 21. The connecting element 23 is bevelled and provided at the bevelled end with a horizontally located connecting element pin 26 to which the wing 4 is rotationally mounted. At the point of connection to the connecting element 23, the wing 4 is bevelled such that the point of connection of the wing 4 and the connecting element 23 is below the level of the central frame 2. The wing 4 is further provided with a mount 25 of the balancing piston, in which the other end of the balancing piston 22 is rotationally mounted. The mounting of the second wing 4 is performed in the same manner on the other side of the central frame 2.

The balancing piston 22 balances the pressure acting on the individual components of the agricultural device 1. Pressure regulation in the balancing piston 22 is done by a hydraulic mechanism, i.e. by pressurising the balancing piston 22 in order to extend or retract it, thereby changing its length, for example by a maximum of 15 cm. By pressurising and extending the balancing piston 22 in the working position of the agricultural device 1, the weight of the towing device 100 is transferred to the travel wheels 7 and the working units 6, thereby achieving greater downforce of the working units 6 on the soil being processed. In the transport position of the agricultural device 1 the balancing piston 22 then compensates the weight of the wings 4 with the working sections 5, thereby reducing the unwanted lifting of the towing device 100.

In an exemplary embodiment, the coupling mechanism 3 is embodied using a coupling pin 26 that passes through the central frame 2 and the towing device 100, thereby ensuring their rotational connection.

### INDUSTRIAL APPLICABILITY

The invention can be used in the field of agriculture for soil processing, especially before sowing or when sowing new crops.

### LIST OF REFERENCE NUMERALS

1—agricultural soil processing device
2—central frame
3—coupling mechanism
4—wing
41—wing strut
400—axis of rotation of the rotational mounting of the wings
5—section of working units
51—strut of the section
500—axis of rotation of the rotational mounting of the section of working units
6—working units
7—travel wheel
8—locking rotational mechanism
9—row of working units
10—support rod
10a—tilting part of the support rod
10b—tipping part of the support rod
11—mount
12—sowing machine
13—strut of the support rod
14—articulated joint
14a—articulated joint strut
15—distribution head
16—inlet of granular material
17—hopper
18—reclinable mount
19—latch of the support rod
20—transport latch
21—frame pin
22—balancing piston
23—connecting element
24—connecting element pin
25—mount of the balancing piston
26—coupling pin
100—towing device
101—central axis of the agricultural device

1. An agricultural soil processing device comprising a central frame provided with a coupling mechanism adapted for mounting to a towing device provided with a mount, wings rotationally mounted to the central frame, sections of working units rotationally mounted to the wings, wherein the sections are comprised of at least one row of working units, at least one travel wheel mounted to at least one the wing by a locking rotational mechanism, and a support rod rotationally mounted to at least one of the wings and connected to the mount, wherein an axis of rotation of a rotational mounting of the support rod to the wing is vertical and parallel to an axis of rotation of a rotational mounting of the wings to the central frame, wherein the support rod comprises a tilting part and a tipping part, wherein the tilting part and the tipping part are rotationally connected by an articulated joint, and wherein the tilting part is tiltable between horizontal and vertical position and tipping part is configured for being tipped to the wing and titled away from the wing.

2. The agricultural soil processing device of claim 1, further comprising at least one distribution head rotationally mounted on the section of working units.

3. The agricultural soil processing device of claim 1, wherein the mount and the tilting part of the support rod are provided with latches adapted to connect the mount and the tilting part of the support rod.

4. The agricultural soil processing device of claim 3, wherein the connection of the latches is secured by a lock.

5. The agricultural soil processing device of claim 1, wherein the support rod provided with a strut rotationally mounted to the support rod and the wing, and wherein the strut is adapted to tip the support rod to the wing.

6. The agricultural soil processing device of claim 1, wherein the articulated joint is provided with an articulated joint strut mounted to the tilting part and the tipping part is adapted to lift the tilting part.

7. The agricultural soil processing device of claim 6, wherein the strut is a piston of a hydraulic cylinder.

8. The agricultural soil processing device of claim 1, wherein the wings are provided with transport latches adapted to be connected together.

9. A method of folding the agricultural soil processing device, wherein the agricultural device comprises at least a central frame, wings rotationally mounted to the central frame and provided with transport latches, sections of working units rotationally mounted to the wings and provided with at least one row of working units, at least one travel wheel mounted to each wing by a locking rotational mechanism, and support rods rotationally mounted to the wings and connected to a mount of a towing device, wherein the support rods comprise a tilting part and a tipping part connected rotationally by an articulated joint, wherein moving the agricultural device from the working position to the transport position comprises the following steps:
a) disconnecting the support rods and the mount of the towing device;
b) lifting the sections of working units by rotating the sections around the wings;
c) folding a first one of the wings to the central axis of the agricultural device by rotating the first one of the wings at the point of rotational connection to the central frame;
d) folding a second one of the wings to the central axis of the agricultural device by rotating the second one of the wings at the point of rotational connection to the central frame;
e) tilting the tilting part of the support rods to the vertical position;
f) tipping the tipping part of the support rods to the wings;
g) rotating the travel wheels in the direction of travel of the agricultural device, and
h) connecting the transport latches of opposite ones of the wings.

10. The method of folding the agricultural soil processing device of claim 9, wherein the agricultural device further comprises at least one distribution head rotationally mounted to the sections of working units, and wherein the distribution head is reclined to the sections of working units after the step of disconnecting the support rods and the mount and before the step of folding the first and second ones of the wings to the central axis of the agricultural device.

11. The method of folding the agricultural soil processing device claim 9, wherein the articulated joint is provided with an articulated joint strut mounted to the tilting part and the tipping part, and wherein the tilting of the tilting part of the support rods is performed by retracting the articulated joint strut.

12. The method of folding the agricultural soil processing device of claim 9, wherein the support rods are provided with a strut of the support rods rotationally mounted to the support rods and the wings, and wherein the reclining of the reclining part to the wings is performed by retracting the strut of the support rods.
